(19) United States
(12) Patent Application Publication
(10) Pub. No.: US 2010/0240014 A1
(43) Pub. Date: Sep. 23, 2010

(54) Toothpaste Scoops

(76) Inventor: Katie Vegas, Harvey, LA (US)

Correspondence Address: MEREK, BLACKMON & VOORHEES, LLC, 673 S. WASHINGTON ST., ALEXANDRIA, VA, 22314, US

(21) Appl. No.: 12/407,063

(22) Filed: Mar. 19, 2009

(51) Int. Cl. A61C 17/00

(52) U.S. Cl. 433/216

(57) ABSTRACT

A tubeless toothpaste container includes a sheet of individual containers of toothpaste tubs. By pealing back or removing the lid on a particular tub, the toothpaste tub is exposed. Toothpaste may be applied to a toothbrush by rolling the brush element through the toothpaste to apply a desired amount of toothpaste without requiring squeezing a tube. A number of tubs may be provided on a number of sheets to provide discrete containers of toothpaste to provide very accessible toothpaste

### BACKGROUND OF THE INVENTION

1. Field of the Invention

The present invention relates to a novel way of presenting toothpaste to a user.

2. Description of the Prior Art

Toothpaste for many years came in a metal based tube that was prone to cracking, leaking and creating a general mess. More recently, the tubes have been replaced by plastic tubes that are crack resistant. However, the problem remains that as the toothpaste is used, the tube remains the same, but the amount of paste is lessened. To force the remaining toothpaste out of the tube, requires an amount of dexterity and manual manipulation by the hand to squeeze the paste from the bottom of the tube along the tube and out the mouth of the tube. This is especially true as the plastic tubes tend to maintain their original shape instead of conforming to the volume of paste remaining in the tubes. Users having reduced hand strength, arthritis, or limited dexterity may find it difficult or inconvenient to use these types of tubes.

The present invention uses shallow trays in which the user can easily dip the toothbrush into a small amount of paste to load the toothbrush with the right amount of toothpaste.

None of the prior shows this type of toothpaste applicator.

### SUMMARY OF THE INVENTION

Accordingly, it is a principal object of a preferred embodiment of the invention to provide a toothpaste receptacle that has an open design to prevent the drawbacks of tube based toothpaste

It is another object of the invention to provide a toothpaste container having a tub sized to receive the brush of a toothbrush to apply toothpaste thereto.

It is a further object of the invention to provide sheets of toothpaste tubs to provide a large quantity of toothpaste and tubs in a convenient package.

Still another object of the invention is to provide a seal that is easily removable to expose the toothpaste for access by the user.

It is an object of the invention to provide improved elements and arrangements thereof in an apparatus for the purposes described which is inexpensive, dependable and fully effective in accomplishing its intended purposes.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is top plan view of a tray of toothpaste tubs according to one aspect of the invention.

FIG. 2 is a front elevation view of a tray of toothpaste containers according one aspect of the invention.

Similar reference characters denote corresponding features consistently throughout the attached drawings.

### DETAILED DESCRIPTION OF THE PREFERRED EMBODIMENT(S)

The present invention is to an improved holder for toothpaste and a method for applying the toothpaste to a toothbrush.

A holder 10 for toothpaste is shown. The holder according to one aspect includes a sheet 12 for connecting a number of individual containers 14. Each container 14 may include a tub 16 extending above and/or below the sheet 12. The tub may have a top or lid 18 to keep the toothpaste fresh when not in use or while being shipped. The lid preferably is a peel back lid such as found on condiments or the like. The lid may be a one time use, such as an adhesively attached aluminum or paper based foil. A tab 20 (“pull tab”) may be included as a handhold for initiating removal of the lid. For example, grasping the tab 20 and pulling up may apply enough force to overcome the adhesive attaching the lid 18 to the tub 16 or sheet 12. The lid may then be disposed of after exposing an amount of toothpaste (not shown) in the tub for several applications of toothpaste to a toothbrush or equivalent device. A user can then dip the head of a toothbrush (not shown) in the tub until a desired amount of toothpaste is applied to the brush element. This requires significantly less hand strength and dexterity than squeezing toothpaste out of a tube, especially when the tube is significantly empty.

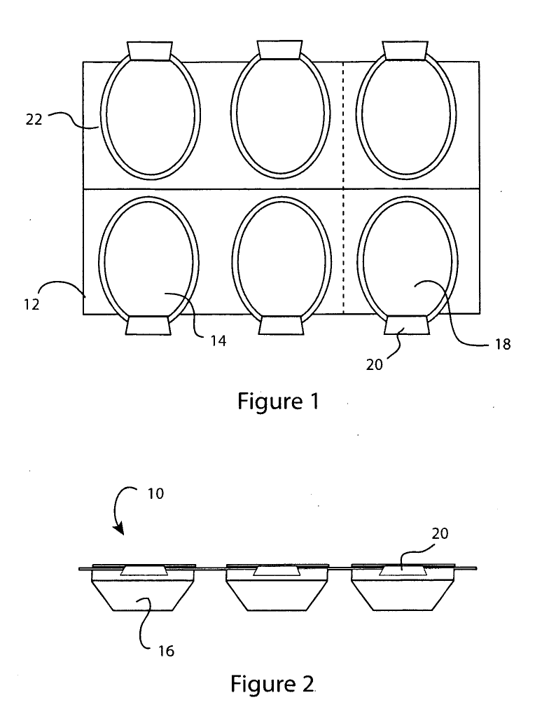

According to another embodiment of the invention, the lid may be resealable. By providing a mating ridge 22 on the tub or sheet and on channel 22 on the lid 18, pressing the lid back down on the sheet with the channel and ridge aligned will reseal the lid over the toothpaste to accommodate movement of the holder (such as in preparation of travel) or to preserve the freshness of the toothpaste for extended uses or to allow larger tubs of toothpaste to be used. While six containers are shown in FIG. 1, one skilled in the art would recognize that a larger or smaller number of containers could be used. Additionally, the sheets of containers could be stacked and placed within a single box to provide a large number of containers within one unit.

The size of each container is preferably considerably smaller than a tube of toothpaste to facilitate the user scooping a small, application-sized amount of toothpaste on the toothbrush without creating a mess. For example, a standard tube of toothpaste is approximately 7.8 ounces. It may take 20 trays of six containers each to hold the same amount of toothpaste.

The sheets 12 may include perforations or scoring 30 to allow the sheets to be divided easily into smaller packets to fit into a purse or suitcase for weekend travel, for example or to dispose of empty containers. The lid 18 may also be hinged or otherwise attached to the tub or sheet to prevent the lid from being separated from the sheet.

The tray 10 may be disposable or may be refillable. The trays may contain indicia to indicate proper use of the tubs or showing the best way to apply the toothpaste. However, preferably, the sheets and lid area include indicia such as advertising or pleasing art. The designs may attract consumers or children with scenes from favorite movies, TV shows or cartoons. The area may include product ties in or advertising that are sellable to other parties to defray part of the cost of packaging or increase the profitability of the product.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A method of applying toothpaste to a toothbrush, comprising:
providing a toothbrush having a handle and an array of bristles at an end of the toothbrush opposite said handle;
providing a toothpaste container having a tub and a lid and an amount of toothpaste in said tub;
removing said lid from said tub to expose an opening in said tub, wherein said opening is larger than said array of bristles of said toothbrush;
brushing said toothbrush across an upper surface of said toothpaste within said tub opening to cause a second amount of toothpaste to adhere to at least a portion of said array of toothbrush bristles.

2. The method of claim 1, further including:
providing said tub as an array of tubs interconnected by a sheet securing said tubs together and where each tub in said array includes toothpaste.

4. The method of claim 1, further including:
providing said tub as an array of tubs interconnected by a sheet securing said tubs together and where at least a plurality of tubs in said array includes toothpaste.

5. The method of claim 4, further including:
providing said tub as an array of tubs interconnected by a sheet securing said tubs together and where at least a plurality of tubs in said array includes toothpaste.

6. The method of claim 1, further including:
providing said tub as an array of tubs interconnected by a sheet securing said tubs together and where at least a plurality of tubs in said array includes toothpaste;
providing a number of said sheets securing having an array of tubs per sheet packaged in one box.

7. A toothpaste system comprising:
a sheet having a number of tubs contained therein;
each said tub having a planar lid for sealing said tub from said environment;
each said tub having an opening for receiving bristles of a toothbrush;
each said tub having an amount of toothpaste for applying to the bristles;
brushing said toothbrush across an upper surface of said toothpaste within said tub opening to cause a second amount of toothpaste to adhere to at least a portion of said array of toothbrush bristles.

8. The system of claim 7, further wherein said tubs are arranged as an array of tubs interconnected by a sheet securing said tubs together.

9. The method of claim 7, further wherein said tubs are arranged as an array of tubs interconnected by a sheet securing said tubs together and where at least a plurality of tubs in said array includes toothpaste.

10. The method of claim 9, further including:
providing said tub as an array of tubs interconnected by a sheet securing said tubs together and where at least a plurality of tubs in said array includes toothpaste.

11. The method of claim 7, wherein said tubs are arranged as an array of tubs interconnected by a sheet securing said tubs together and where at least a plurality of tubs in said array includes toothpaste;
and wherein a number of said sheets securing having an array of tubs per sheet are packaged in one box.
